(19) United States
(12) Patent Application Publication
(10) Pub. No.: US 2025/0126511 A1
(43) Pub. Date: Apr. 17, 2025

(54) METHODS AND APPARATUSES FOR ASSOCIATING SINGLE-MODAL FLOWS FOR SYNCHRONIZATION AND RESOURCE ALLOCATION

(71) Applicant: InterDigital Patent Holdings, Inc., Wilmington, DE (US)

(72) Inventors: Michael Starsinic, Newtown, PA (US); Saad Ahmad, Montreal (CA); Samir Ferdi, Kirkland (CA); Magurawalage Chathura Madhusanka Sarathchandra, London (GB); Michelle Perras, Montreal (CA); Mona Ghassemian, Kent (GB); Achref Methenni, Montreal (CA); Rocco Di Girolamo, Laval (CA)

(21) Appl. No.: 18/832,441

(22) PCT Filed: Jan. 18, 2023
(86) PCT No.: PCT/US2023/011015

§ 371 Date: Jul. 23, 2024

Related U.S. Application Data
(60) Provisional application No. 63/303,689, filed on Jan. 27, 2022.
(60) Provisional application No. 63/338,582, filed on May 5, 2022.

(51) Int. Cl. H04W 28/02; H04L 12/14; H04L 41/0894; H04W 48/20

(52) U.S. Cl. CPC H04W 28/0268; H04L 12/1407; H04L 41/0894; H04W 48/20

(57) ABSTRACT

Procedures, methods, architectures, apparatuses, systems, devices, and computer program products directed to methods, architectures, apparatuses, systems directed for associating single-modal flows for synchronization and resource allocation.

### CROSS-REFERENCE TO RELATED APPLICATIONS

The present application claims the benefit of U.S. Provisional Patent Application No. 63/303,689 filed Jan. 27, 2022, and U.S. Provisional Patent Application No. 63/338,582 filed May 5, 2022, each of which is incorporated herein by reference.

### TECHNICAL FIELD

The present disclosure is generally directed to the fields of communications, software and encoding, including, for example, to methods, architectures, apparatuses, systems directed for associating single-modal flows for synchronization and resource allocation.

### BACKGROUND

It may be known that there is a strong dependency between a single-modal data flows in a multi-modal data set. The dependency may be based on multiple factors.

It may be required that data from certain single-modal data flows reach their destinations within a synchronization threshold time so that data is delivered to the application layer at the appropriate time.

Some of the single-modal data flows in a multi-modal data set may have varying priority levels. For example, one single-modal data flow may be critical, and the quality of experience will be noticeably impacted if the single-modal data flow experiences just a few delayed or dropped packets. A second single-modal data flow in the same multi-modal data set may be less important, or even optional, such that user experience will not be significantly impacted if the second single-modal data flow is delayed, dropped, or not successfully established.

The 5G System may currently support no feature that allows the system to be configured to know which single-modal data flows belong to the same multi-modal data set.

There is a need for improving association between single-modal data flows and multi-modal data set.

### SUMMARY

In an embodiment, a method, implemented in a wireless transmit/receive unit (WTRU), may comprise a step of receiving a first message comprising an information including a session identifier for a session that is associated with data flows of at least one other WTRU. The method may further comprise a step of transmitting, to a network node, a packet data unit (PDU) session establishment request comprising a second message including the session identifier; and a step of receiving, from the network node, a PDU session establishment accept message indicating quality of service (QoS) rules for the WTRU to apply to traffic that is associated with the PDU session.

The method may further comprise a step of receiving a PDU modification command that indicates an index associated with one or more of the indicated QoS rules.

The step of transmitting may comprise sending the session identifier in both non-access stratum mobility management (NAS-MM) and non-access stratum session management (NAS-SM) parts of a NAS message. The first message may be received by an application of the WTRU, wherein the application may be an extended reality engine of the WTRU.

Prior to receiving the first message, the method may comprise a step of performing a discovery procedure with an extended reality application provider. The PDU session establishment request may be triggered by an extended reality engine of the WTRU.

In an embodiment, a wireless transmit/receive unit (WTRU) comprising a processor, a transceiver unit and a storage unit, and may be configured to receive a first message comprising an information including a session identifier for a session that is associated with data flows of at least one other WTRUs. The WTRU may be further configured to transmit, to a network node, a packet data unit (PDU) session establishment request comprising a second message including the session identifier; and configured to receive, from the network node, a PDU session establishment accept message indicating quality of service (QoS) rules for the WTRU to apply to traffic that is associated with the session.

The WTRU may be further configured to receive a PDU modification command that indicates an index associated with one or more of the indicated QoS rules.

Transmit to the network node may comprise sending the session identifier in both non-access stratum mobility management (NAS-MM) and non-access stratum session management (NAS-SM) parts of a NAS message. The first message may be received by an application of the WTRU, and the application may be an extended reality engine of the WTRU.

The WTRU may be configured to perform a discovery procedure with an extended reality application provider, prior to receive the first message.

The PDU session establishment request may be triggered by an extended reality engine of the WTRU.

In an embodiment, a method, implemented in a network node may comprise a step of receiving, from a WTRU, a packet data unit (PDU) session establishment request comprising a session identifier. The method may further comprise a step of determining, based on the session identifier, quality of service (QoS) rules for the WTRU to apply to traffic that is associated with the PDU session; and a step of transmitting, to the WTRU, a PDU session establishment accept message indicating the quality of service (QoS) rules for the WTRU to apply to traffic that is associated with the PDU session.

The method may further comprise a step of transmitting a first message comprising the session identifier to a policy control function (PCF); and a step of receiving, from the PCF, a second message indicating policy and charging control (PCC) rules that are associated with the session identifier; and wherein determining QoS rules is based on the PCC rules that are associated with the session identifier.

The method may further comprise a step of transmitting a PDU modification command that indicates an index associated with one or more QoS rules of the indicated QoS rules. The session identifier may be used in a user plane function (UPF) selection procedure.

The method may further comprise a step of receiving a third message comprising information on anticipated traffic. The method may further comprise a step of determining that the traffic is anticipated based on the received information; and a step of transmitting a notification to an access and mobility function (AMF) indicating that traffic is anticipated.

A session management function may use the session identifier to determine a data network name and a single network slice selection assistance information to associate with the PDU session establishment request.

In an embodiment, a network node, comprising a processor, a transceiver unit and a storage unit, may be configured to receive, from a WTRU, a packet data unit (PDU) session establishment request comprising a session identifier. The network node may be further configured to determine, based on the session identifier, quality of service (QoS) rules for the WTRU to apply to traffic that is associated with the PDU session; and configured to transmit, to the WTRU, a PDU session establishment accept message indicating the quality of service (QoS) rules for the WTRU to apply to traffic that is associated with the PDU session.

The network node may be further configured to transmit a first message comprising the session identifier to a policy control function (PCF), and to receive, from the PCF, a second message indicating policy and charging control (PCC) rules that are associated with the session identifier. Determining QoS rules may be based on the PCC rules that are associated with the session identifier.

The network node may be configured to transmit a PDU modification command that indicates an index associated with one or more QoS rules of the indicated QoS rules. The session identifier may be used in a user plane function (UPF) selection procedure.

The network node may be further configured to receive a third message comprising information on anticipated traffic. The network node may be further configured to determine that the traffic is anticipated based on the received information; and to transmit a notification to an access and mobility function (AMF) indicating that traffic is anticipated.

A session management function may use the session identifier to determine a data network name and a single network slice selection assistance information to associate with the PDU session establishment request.

In an embodiment, a method, implemented in a first wireless transmit/receive unit (WTRU), may comprise a step of receiving, from a network node, a paging message. The method may further comprise a step of transmitting, to the network node, a service request message. The method may further comprise a step of receiving, from the network node, a service accept message comprising information including a traffic anticipated information element. The traffic anticipated information may trigger the WTRU to take action to prepare for traffic. The action may send a notification to applications that are hosted on the WTRU or the action may send a notification to other devices that are communicatively connected to the WTRU.

The notification may comprise indication on a time when the traffic is anticipated. The traffic anticipated information may comprise indication on a time when the traffic is anticipated.

In another embodiment, a method, implemented in a WTRU, may comprise a step of receiving, from a network node, a first non-access stratum (NAS) message, wherein the first NAS message comprises first information indicating more than one set of QoS rules that are associated with a same PDU session; and a step of receiving, from the network node, a second NAS message, wherein the second NAS message comprises second information indicating to the WTRU which of the more than one sets of QoS rules should be applied to the PDU session.

The first NAS message may be a PDU session establishment request or a PDU session modification request. The second NAS Message may be a PDU session modification request. The first NAS message may comprise third information indicating an index of at least one of the QoS rules and the second NAS message may comprise a fourth information indicating the index of the at least one of QoS rules should be applied to the PDU session.

In another embodiment, a method, implemented in a WTRU, may comprise a step of receiving, from a network node, a NAS message comprises information including more than one set of QoS rules that are associated with a same PDU session, and an index for one or more QoS rule. The method may comprise a step of receiving a packet of data and an index value from an application. The method may further comprise a step of selecting one of the one or more QoS rules based on the index value; and a step of transmitting the packet of data using the selected one QoS rule. The NAS message may be a PDU session establishment request or a PDU session modification request.

In an embodiment, a wireless transmit/receive unit (WTRU) comprising a processor and a non-transitory computer-readable storage medium storing instructions operative, when executed on the processor, may perform functions including: receiving, from a network node, a paging message; transmitting, to the network node, a service request message; receiving, from the network node, a service accept message comprising information including a traffic anticipated information element. The traffic anticipated information may trigger the WTRU to take action to prepare for traffic.

In another embodiment, a wireless transmit/receive unit (WTRU) comprising a processor and a non-transitory computer-readable storage medium storing instructions operative, when executed on the processor, may perform functions including: receiving, from a network node, a first non-access stratum (NAS) message, wherein the first NAS message comprises first information indicating more than one set of QoS rules that are associated with a same PDU session; and receiving, from the network node, a second NAS message, wherein the second NAS message comprises second information indicating to the WTRU which of the more than one sets of QoS rules should be applied to the PDU session.

In another embodiment, a wireless transmit/receive unit (WTRU) comprising a processor and a non-transitory computer-readable storage medium storing instructions operative, when executed on the processor, may perform functions including: receiving, from a network, a NAS message comprises information including more than one set of QoS rules that are associated with a same PDU session, and an index for at least one QoS rule; and receiving a packet of data and an index value from an application, and using the index value from the application to select one of the QoS rules that were received in the NAS message and using the selected QoS rule to transmit the packet.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref”) in the FIGs. indicate like elements, and wherein:

FIG. TA is a system diagram illustrating an example communications system;

FIG. 1B is a system diagram illustrating an example wireless transmit/receive unit (WTRU) that may be used within the communications system illustrated in FIG. TA;

FIG. 1C is a system diagram illustrating an example radio access network (RAN) and an example core network (CN) that may be used within the communications system illustrated in FIG. TA;

FIG. 1D is a system diagram illustrating a further example RAN and a further example CN that may be used within the communications system illustrated in FIG. 1A;

FIG. 2 is a system diagram illustrating an example of a unicast and a multicast supported within a Data Network associated with a 5G Virtual network group;

FIG. 3 is a system diagram illustrating an example of three traffic forwarding methods available in the 5G system for 5G virtual network communication;

FIG. 4 is a system diagram illustrating an example of a 5G extended reality interfaces and architectures;

FIG. 5 is a message flow diagram illustrating an example of associating a PDU session with a multi-modal data set;

FIG. 6 is a message flow diagram illustrating an example of a creation or modification of a multi-modal data set;

FIG. 7 is a message flow diagram illustrating an example of a configuration of 5G system for correct policy detection and enforcement.

FIG. 8 is a message flow diagram illustrating an example of a WTRU reception of an early data warning;

FIG. 9 is a flowchart illustrating an example of a method implemented in a WTRU for setting up a multi-modal data flow; and

FIG. 10 is a flowchart illustrating an example of a method implemented in a network node for setting up a multi-modal data flow

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description.

Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

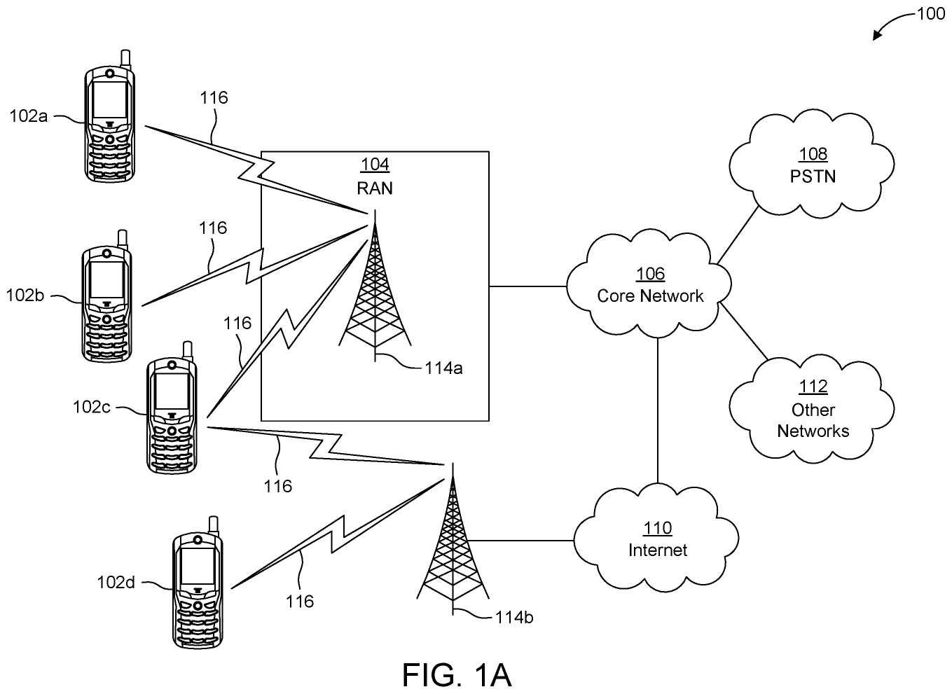

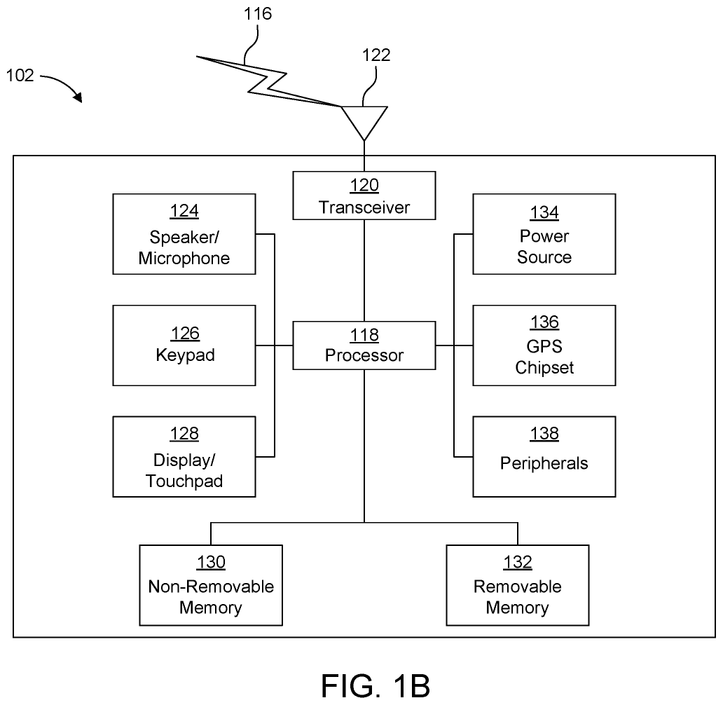

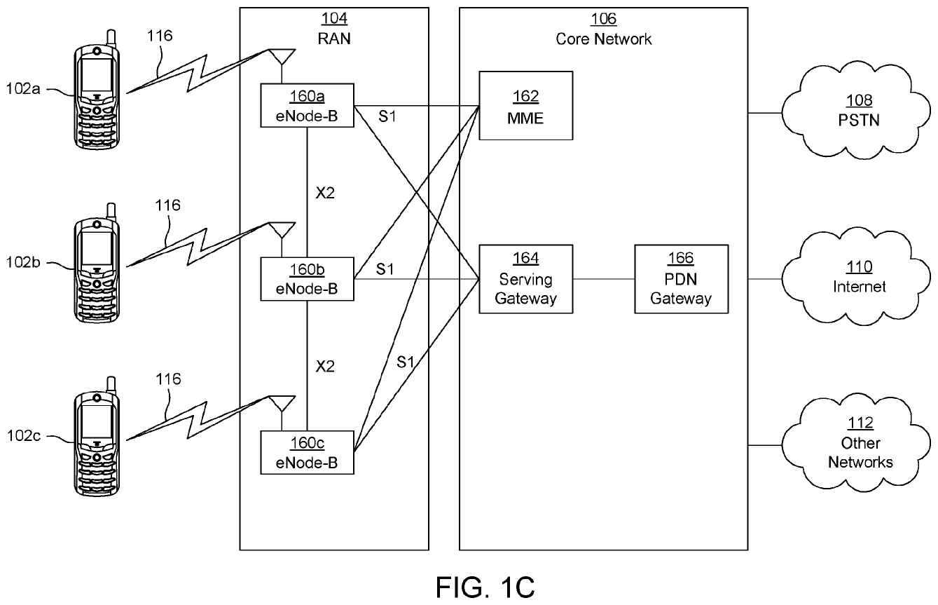

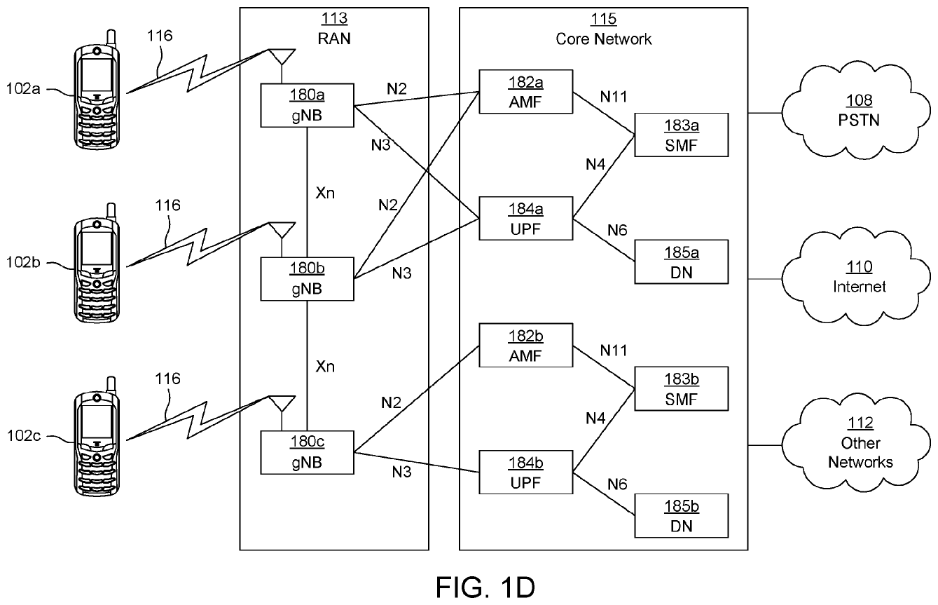

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell.

As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type ofnetwork configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately.

The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b maybe connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-ID, and the corresponding description of FIGS. 1A-ID, one or more, or all, of the functions described herein with regard to any of. WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following description is for exemplary purposes and does not intent to limit in any way the applicability of the methods described herein to any wireless technology and/or to other technology, when applicable. The term network in this disclosure may refer to one or more gNBs which in turn may be associated with one or more Transmission/Reception Points (TRPs), or to any other node in the radio access network.

As described in document TR 22.847, a multi-modal synchronization threshold may be defined as a maximum tolerable temporal separation of the onset of two stimuli, one of which is presented to one sense and the other to another sense, such that accompanying sensory objects are perceived as being synchronous.

The following description describes functionality that may be executed by a 5G extended reality (5GXR) application provider, a 5GXR AF, and a 5GXR AS. It should be appreciated that this is a logical description and that a server or a network function may provide all or parts of the 5GXR application provider, 5GXR AF, and 5GXR AS functionality. In other words, the terms application server, application provider, and application function may be used interchangeably.

A WTRU may host a 5G XR aware application, XR session handler, a 5GXR client, and/or an XR engine. In this document, 5G XR aware application, XR session handler, a 5GXR client, and XR engine are sometimes referred to as an application. The specification herein may equally apply to a 5G XR aware application, an XR session handler, a 5GXR client, an XR engine, or any type of application.

Document TR 22.847, study on supporting tactile and multi-modality communication services. More particularly, document TR 22.847, Stage 1 (Release 18), V 18.1.0, defines Multi-modal Data as input data from different kinds of devices/sensors or the output data to different kinds of destinations (e.g., one or more WTRUs) required for the same task or application. Multi-modal Data may consist of more than one single-modal data and there may be strong dependency among each Single-modal Data. Single-modal Data can be seen as one type of data.

A device or sensor that generates (e.g., sends) single-modal data may be a WTRU or may use a WTRU to send single-modal data to a network. Single-modal data may be sent to applications that are hosted on other WTRUs or applications that are hosted on network servers.

A device or sensor that receives single-modal data may be a WTRU or may use a WTRU to receive single-modal data from a network. Single-modal data may be received from applications that are hosted on other WTRUs or applications that are hosted on network servers.

Single-modal data may be described as being a data flow to and/or from a WTRU and multi-modal data may be described as consisting of multiple data flows to and/or from multiple WTRUs.

A multi-modal data set may be the set of single-modal data flows that are used for the same task or application. For example, a multi-modal data set may be a set if IP flows and/or QoS flows between multiple WTRUs and a single application server. For example, the IP flows may carry sensor data, video information, haptic data, audio data, etc.

An example of Local Area Network (LAN) support in the 5G system is described below.

As described in reference TS 23.501, system architecture for the 5G system (5GS); Stage 2; V 17.3.0, the 5G system may support management of 5G virtual network (VN) group identification and membership as well as 5G VN group data. In order to support dynamic management of 5G VN Group identification and membership, a network exposure function (NEF) may expose a set of services to manage (e.g., add/delete/modify) a 5G VN group and 5G VN members. The NEF also may expose services to dynamically manage 5G VN group data.

A VN group may be associated with configuration information called “5G VN group Data”. 5G VN group data may include a PDU session type, a DNN, a single network slice selection assistance information (S-NSSAI), and an application descriptor.

The 5G VN group management may be configured by a network administrator (e.g., via the OAM system) or it can be managed dynamically by an AF (e.g., via the NEF).

The same procedure may be used for creating and updating the group.

Once the group information is configured (or modified) in the unified data repository (UDR), the information may be sent to the policy control function (PCF). The PCF may use this information to construct a UE/WTRU route selection policy (URSP) that may cause certain traffic to use the DNN and S-NSSAI that is associated with the VN Group. The URSP rule may then be sent to one or more WTRUs that are part of the VN group.

The network may associate a VN group with a DNN and, when the WTRU establishes a PDU Session to the DNN, the network may trigger secondary PDU Session authentication.

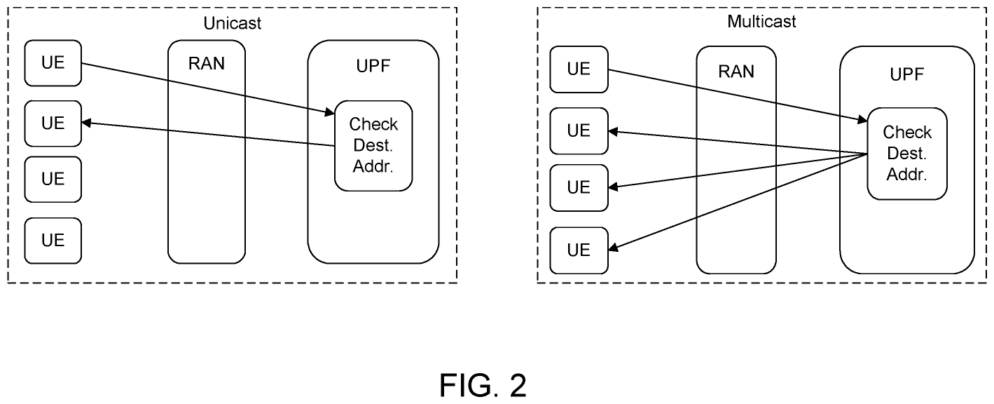

As shown in FIG. 2, unicast and multicast may both be supported within the DN that is associated with a 5G VN Group. The PDU session anchor UPF may determine whether the communication is for unicast or multicast based on the destination address of the received data.

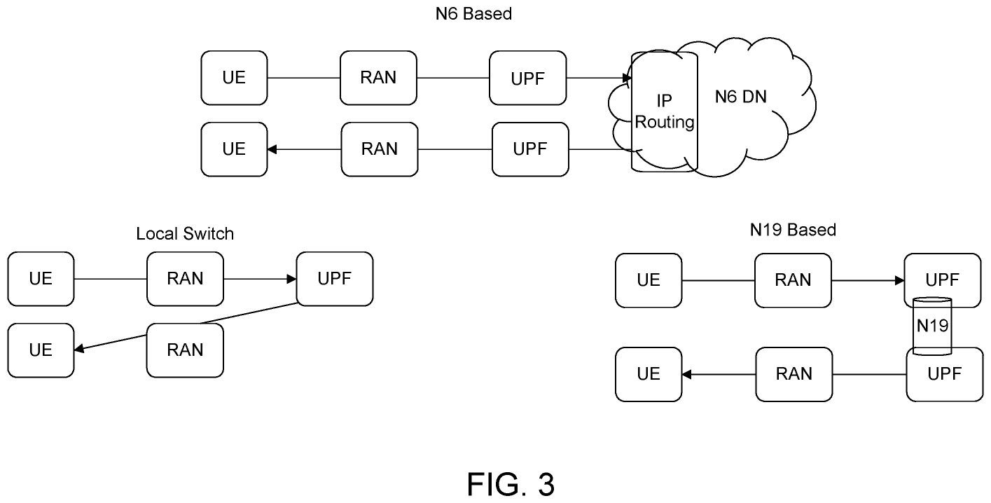

As shown in FIG. 3, three traffic forwarding methods may be available in the 5G system for 5G VN communication. N6 Base Forwarding, N19 Base Forwarding, and Local Switching are illustrated in FIG. 3.

An example of 5G application layer architecture for XR is described below.

Document TR 26.928, AN support in the 5G System; V 16.1.0, describes application layer architectures to support XR in the 5G system. The application layer architectures relate to client and network architectures, APIs and media processing functions that support XR use cases.

Error!Reference source not found. 4 is copied from document TR 26.928 and illustrates the following aspects of an example application layer architectures to support XR in the 5G system.

The WTRU may host a 5GXR client that interfaces with a 5GXR application function (AF). The interface between the 5GXR client and 5GXR AF may be called X5. X5 messages may be sent over the user plane and may be API based. The X5 interface may allow the 5GXR client to indirectly access services that are exposed by the NEF and PCF. A PDU session may be used to carry the X5 traffic between the WTRU and data network (DN) that hosts the 5GXR AF.

The WTRU may host a 5GXR client that interfaces with a 5GXR application server (AS). The interface between the 5GXR client and 5GXR AS may be called X4. X4 messages may be sent over the user plane and may be API based. X4 interfaces may allow the 5GXR Client to get access to XR related data. The traffic that is carried on the X4 interface may be single-modal data flow(s) that are part of a multi-modal data set. In other words, the X4 interface may be carried over the user plane. A PDU session may be used to carry the X4 traffic between the WTRU and data network (DN) that hosts the 5GXR AS.

The WTRU may host a 5GXR aware application that interfaces with a 5GXR application provider. The interface between the 5GXR aware application and 5GXR application provider may be called X8. The X8 interface is used for information exchange between the 5GXR aware application and the 5GXR application provider, for example to provide service access Information to the 5GXR application provider. A PDU session may be used to carry the X8 traffic between the WTRU and data network (DN) that hosts the 5GXR application provider.

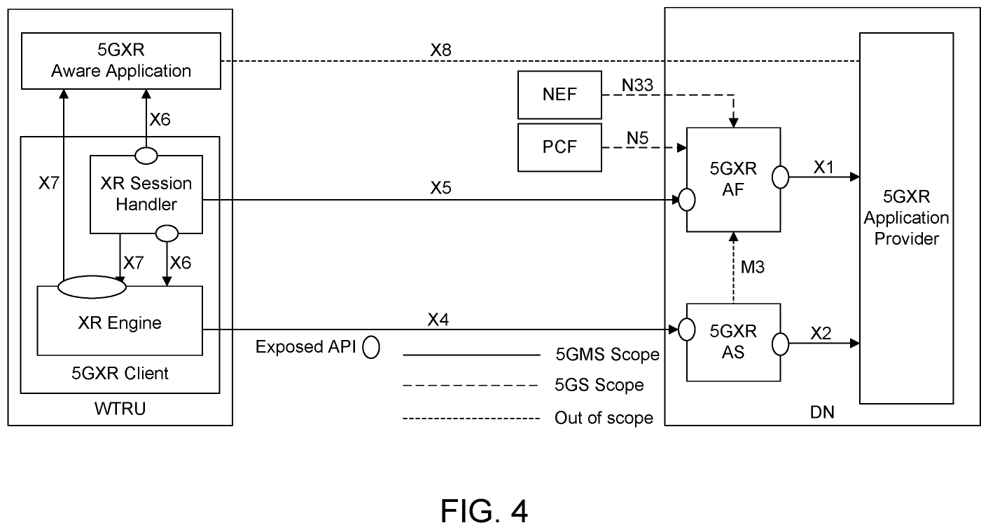

In the context of FIG. 4 and the rest of this specification, the 5GXR AF, 5GXR AS, and 5GXR application provider may be called application servers, application functions, or network servers.

The application layer architecture of FIG. 4 is based on the application layer architecture of TS 26.501, 5G Media Streaming (5GMS); General description and architecture; V 17.0.0. TS 26.501 defines a provisioning session identifier. The provisioning session and the associated provisioning session identifier may be created by the application provider.

The application provider may create a provisioning session with the AF and may start provisioning the usage of the 5G media streaming system. During the establishment phase, the used features may be negotiated, and detailed configurations are exchanged. The AF may receive service access information for X5 (Media Session Handling) and, where media content hosting may be negotiated, service access information for X2 (Ingestion) and X4 (Media Streaming) as well. This information may be needed by the WTRU client to access the service. Depending on the provisioning, only a reference to the service access information might be supplied.

### Example of 5G QoS Framework

As described in TS 23.501, the 5G QoS model may be based on QoS Flows. A QoS Flow may be associated with QoS requirements as specified by QoS parameters and QoS characteristics.

The QoS flow may be the finest granularity of QoS differentiation in the PDU Session. A QoS flow ID (QFI) may be used to identify a QoS Flow in the 5G system. User plane traffic with the same QFI within a PDU session may receive the same traffic forwarding treatment (e.g., scheduling, admission threshold). The QFI may be carried in an encapsulation header on N3 (and N9) e.g., without any changes to the e2e packet header.

A QoS flow may be controlled by the SMF and may be preconfigured or established via the PDU Session Establishment procedure or the PDU session modification procedure.

Any QoS flow may be characterized by a QoS profile provided by the SMF to the AN via the AMF over the N2 reference point or preconfigured in the AN, one or more QoS rule(s) and optionally QoS flow level QoS parameters associated with these QoS rule(s) which may be provided by the SMF to the WTRU via the AMF over the N1 reference point and/or derived by the WTRU by applying reflective QoS control; and one or more UL and DL PDR(s) provided by the SMF to the UPF.

In the current 5G system design, the SMF may provide, in addition to the QoS profile, a prioritized list of alternative QoS profile(s) to the NG-RAN. An alternative QoS profile may represent a combination of QoS parameters packet delay budget (PDB), PER and guaranteed flow bit rate (GFBR) to which the application traffic is able to adapt. When the NG-RAN sends a notification to the SMF that the QoS profile is not fulfilled, the NG-RAN may, if the currently fulfilled values match an alternative QoS profile, include also the reference to the alternative QoS profile to indicate the QoS that the NG-RAN currently fulfils. The SMF may then send updated QoS rules to the WTRU via the PDU session modification procedure.

An example of UE/WTRU route selection policy (URSP) is described below.

As described in document TS 23.503, policy and charging control framework for the 5G system (5GS); Stage 2; V 17.3.0, URSP rule may be a policy that is used by the WTRU to determine how to route outgoing traffic. Traffic may be routed to an established PDU session, traffic may be offloaded to non-3GPP access outside a PDU session, traffic may be routed via a ProSe Layer-3 WTRU-to-Network relay outside a PDU session or may trigger the establishment of a new PDU session.

Note that a WTRU application may request a network connection using Non-Seamless Offload or ProSe Layer-3 WTRU-to-Network Relay Offload. In such a scenario, the WTRU will use Non-Seamless Offload for this application without evaluating the URSP rules. Otherwise, the WTRU may use URSP rules to determine how to route the application traffic.

Each URSP rule may consist of two parts. The first part of the URSP rule may be a traffic descriptor that may be used to determine when the rule is applicable. A URSP rule may be determined to be applicable when every component in the traffic descriptor matches the corresponding information from the application. The second part of the URSP rule may be a list of route selection descriptors (RSD). The list of route selection descriptors may contain one or more route selection descriptors. The RSDs may be listed in priority order and describe the characteristics of a PDU session that may be used to carry the uplink application data.

Characteristics of a PDU session may include session and service continuity (SSC) Mode, DNN, and S-NSSAI. The RSD may alternatively include a Non-Seamless Offload indication that indicates that the traffic may be sent via non-3GPP access (e.g., WiFi) and outside of any PDU Session.

For every newly detected application, the WTRU may evaluate the URSP rules in the order of rule precedence and may determine if the application matches the traffic descriptor of any URSP rule. When a URSP rule is determined to be applicable for a given application, the WTRU may select a route selection descriptor within this URSP rule in the order of the route selection descriptor precedence.

When a valid route selection descriptor is found, the WTRU may determine if there is an existing PDU session that matches all components in the selected route selection descriptor. When a matching PDU session exists, the WTRU may associate the application to the existing PDU session, e.g., the WTRU may route the traffic of the detected application on this PDU Session. If none of the existing PDU sessions matches the RSD, the WTRU may try to establish a new PDU Session using the values specified by the selected route selection descriptor.

As discussed in TS 24.526, User Equipment (UE) policies for 5G system (5GS); Stage 3; V 17.5.0, once traffic from an application is associated with a PDU session, an event may cause the WTRU to re-evaluate the URSP rules and associate the traffic from the application with a different PDU session. Two examples of events that may trigger URSP re-evaluation are an implementation dependent re-evaluation timer and the WTRU establishing access to a Wi-Fi network that provides internet access without using the 5G system (e.g., Non-Seamless Offload becomes possible).

A traffic descriptor may be an application descriptor, an IP descriptor, a domain descriptor, a non-IP descriptor, a DNN, or connection capabilities. An IP descriptor may be a destination IP 3 tuple(s) (e.g., an IP address or IPv6 network prefix, port number, protocol ID of the protocol above IP).

Examples of use cases causing some issues are described below.

Document TR 22.847 describes multiple use cases that involve the use of multi-modal data. A common theme of several of the use cases is that multiple modalities may be transmitted at the same time to multiple application servers for further processing in a coordinated manner. In summary, information may be collected from the user and environment (e.g., collected from multiple WTRUs), the information is sent to multiple WTRUs, the information may be transferred in separate flows, the network and possibly the WTRUs may need to be aware of the flow “grouping”, and the information needs to be synchronized.

In the scenario of real time remote virtual reality service, a virtual reality (VR) user may use a plurality of independent devices to separately collect video, audio, ambient and haptic data from the person and to receive video, audio, ambient and haptic feedback from one or multiple application servers for a same VR application.

Multiple outcomes may need to reach the distributed WTRUs at the same time. In the scenario of sound field reappearing, different channels of sounds may be sent to the distributed sound boxes to simulate the sound from a particular direction. A small time difference may cause big direction error to impact user experience.

In another use case example, data flows may be established from multiple camera WTRUs to the same application server. The video stream (e.g., flow) from one camera may be more critical than the video steam (e.g., flow) from a second camera. During a period of network congestion, the 5G System should be aware that some flows are more important than others and be able to adjust, drop, or disallow flows when network congestion occurs. Furthermore, packets of same video stream may be of different contributions to user experience, so a layered QoS handling within the video stream can potentially relax the requirement thus lead to higher efficiency.

As described above, there may be a strong dependency between the single-modal data flows in a multi-modal data set. The dependency may be based on multiple factors.

The single-modal data flow in a multi-modal data set may have synchronization requirements. In other words, it may be required that data from certain single-modal data flows reach their destinations within a synchronization threshold time so that data may be delivered to the application layer at the appropriate time (e.g., in a way that is relatively synchronized with the rest of the multi-modal data set).

Some of the single-modal data flows in a multi-modal data set may have varying priority levels. For example, one single-modal data flow may be critical, and the quality of experience may be noticeably impacted if the single-modal data flow experiences just a few delayed or dropped packets. A second single-modal data flow in the same multi-modal data set may be less important, or even optional, such that user experience may not be significantly impacted if the second single-modal data flow is delayed, dropped, or not successfully established.

The 5G system currently supports no feature that allows the system to be configured to know which single-modal data flows belong to the same multi-modal data set. The proposed embodiments of this specification address how elements of the 5G system (e.g., the WTRU and network nodes) may be configured to know which single-modal data flows belong to the same multi-modal data set.

Furthermore, the 5G system may not know how the single-modal data flows in a multi-modal data set depend on one another. In other words, the 5G system may not know if some single-modal data flows are higher priority than other single-modal data flows and the 5G system may not know if there are synchronization requirements between single-modal data flows. The proposed embodiments of this specification may describe what information (e.g., policy information) may be used by the 5G system to optimize the handling of a multi-modal data set.

Once the 5G system is aware of how the single-modal data flows in a multi-modal data set depend on one another, the 5G system may use this information to appropriately prioritize and allocate resources for the single-modal data flows in a multi-modal data set. The proposed embodiments of this specification may describe how the policy information may be used by the 5G system (e.g., the WTRU and network nodes) to appropriately prioritize and allocate resources for the single-modal data flows in a multi-modal data set.

Once the 5G system is aware of how the single-modal data flows in a multi-modal data set depend on one another, the 5G system may also use this information to appropriately synchronize the single-modal data flows in a multi-modal data set. This specification describes how the policy information may be used by the 5G system (e.g., the WTRU and network nodes) to synchronize the single-modal data flows in a multi-modal data set. Synchronizing the single-modal data flows in a multi-modal data set may mean ensuring that all WTRUs are triggered and ready to receive or send data when necessary.

As described earlier, packets of same video stream (e.g., flow) may be of different contributions to user experience. However, the 5G system design may be such that the QoS rules that are applied in the WTRU have granularity that is IP flow based. Thus, the same importance (e.g., QFI) will be applied to all packets of the same IP flow of a PDU Session.

In some scenario, an extended reality media services (XRM) traffic might be exchanged between WTRUs without the involvement of an application server. In such scenario, there needs to be a way for a 5G core network (5GC) to detect that PDU sessions of an XRM session are related/linked so that the 5GC may configure QoS rules and N4 rules of the PDU sessions in a coordinated manner.

An example of configuration by an AF of a 5GXR service provider is described below

According to various embodiments detailed below, an AF of a 5GXR service provider may configure information in the 5G system about a multi-modal data set. As described below, the information includes service requirements for the data flows of the multi-modal data set and the identities of WTRU's that maybe associated with the multi-modal data set.

According to various embodiments detailed below, a WTRU application may obtain multi-modal set information (e.g., a multi-modal set identifier). The WTRU may provide the multi-modal set information to the network during PDU session establishment so that the network may recognize that the PDU session may be associated with the multi-modal data set.

Various embodiments detailed below provides details on enhancements to the QoS framework of the 5G System so that different QoS treatment can be applied to packets of the same flow. QoS framework enhancements may be also described so that the WTRU may (e.g., quickly) change what QoS rules, or treatment, are applied.

According to various embodiments detailed below, an AF may introduce a set of policies per service data flow, depending on XRM session configuration, and may index these policies. A 5GS may be able to derive proper policy charging and control (PCC) rules, QoS rules and N4 rules for each index and may send them to proper network entities along with the index. WTRU hosted applications may communicate an index value to the WTRU, thus conveying a particular configuration (e.g., coded setting), and WTRU may use the index value to select a corresponding QoS rules for the traffic.

According to various embodiments detailed below, the terms 5GXR AF and 5G application function (5GAF) may be used interchangeably.

According to various embodiments detailed below, once a multi-modal data flow is created, the 5G system may ensure that the WTRUs that are associated with multi-modal data set are triggered to be awake (e.g., in the 5GMM-CONNECTED state) when they are requested to send or receive data, thus reducing flow latency

An example of associating a flow with Multi-modal data set is described below.

5GXR aware application (also called 5GXR application) may discover an XR session that it wants to join. This discovery operation may take place over the X8 interface. The XR session may be associated with a multi-modal data set. The XR session may be associated with a session identifier and service access information. As part of the discovery operation, the 5GXR application may receive the session identifier and service access information. This information may be sent to the 5GXR application by the 5GXR service provider via the X8 interface. The 5GXR Application may then provide the information to the XR engine via the X7 reference point and provide the information to the XR session handler via the X6 reference point.

The XR engine may provide the information to the MT part of the WTRU so that it may be used during PDU session establishment. The XR session handler may use the X5 interface to provide the information to the 5GXR AF. The 5GXR AS may use the information to inform the network (e.g., vie the NEF) that the WTRU has joined the session.

Alternatively, the XR session handler may obtain the session ID from the 5GXR AF and use the X7 interface to provide the session ID to the XR engine. The XR engine may then use the session ID during PDU session establishment.

Alternatively, the session ID may be configured on the WTRU using a graphical user interface (GUI) that is hosted by a terminal equipment (TE) part of the WTRU and provided to the MT part of the WTRU via an AT command.

The session identifier may be correlated with a “Provisioning Session identifier”, “Application Identifier”, a “Content Hosting Configuration identifier” or an “Application Identifier”.

An NEF application programing interface (API) may be defined that may allow the 5GXR AF to request the creation of a multi-modal data flow. The NEF API may be a new API or an enhanced version of the Nnef_ParameterProvision API. The Nnef_ParameterProvision API may be used to create a VN group. This API may be enhanced to allow the 5GXR AF to provide the session identifier to the network or the 5GXR AF may provide the network with an application descriptor that maps to the session identifier and was provided to the 5GXR aware application as the session identifier. Provisioning of the session identifier by the 5GXR AF via the NEF is discussed further below.

The 5GXR application may provide the session identifier and service access information to the XR engine via the X7 interface. This may involve the 5GXR application invoking an API that passes the session identifier and service access information to the XR engine.

The single-modal flows of the WTRU that will be associated with the multi-modal data set will be between the XR engine and 5GXR AS and traverse the X4 interface.

When the XR engine is ready to start a single-modal flow that is to be associated with the multi-modal data set, the XR engine may provide the session identifier and a traffic descriptor to the mobile termination (MT) part of the WTRU. For example, the XR engine may be an application that runs in the TE part of the WTRU and the XR engine may invoke an API, such as an AT command (e.g., the +CGDONT AT command may be enhanced to allow the session identifier to be provided to the ME), to provide the session identifier to the MT part of the WTRU. Attention (AT) commands are defined in TS 27.007, AT command set for user equipment (UE); V 17.4.0.

The XR engine may provide the session identifier and traffic descriptor to the MT part of the WTRU, and this may trigger the MT part of the WTRU to send a PDU session establishment request to the 5G core network. The PDU session establishment request may include a data network name (DNN), S-NSSAI, and the session identifier. URSP Rules may be used to determine the DNN or S-NSSAI. Alternatively, the DNN or S-NSSAI may be provided by the XR engine.

Alternatively, the WTRU may provide no DNN or S-NSSAI to the network. The SMF may receive the PDU session establishment request and may use the session identifier to determine that the PDU session may be used to carry single-modal flows that are associated with a multi-modal set, the SMF may use the session identifier to retrieve PCC rules for the PDU session from the PCF, and the SMF may use the session identifier to determine an S-NSSAI and/or DNN to associate with the PDU session if no S-NSSAI and/or DNN was provided by the WTRU in the PDU session establishment request. The PCC rules that are obtained by the PCF may be used to derive QoS rules for the PDU session.

As described earlier, the 5G LAN feature of the 5G system allows the network to associate PDU sessions. All PDU sessions that are associated with the same DNN and S-NSSAI may be associated with the same 5G LAN. It would be inefficient to use the 5G LAN feature, without enhancement, to associate single-modal flows of a multi-modal set. The reason that such an approach would be inefficient is that the 5G LAN feature requires that all PDU sessions to the DNN/S-NSSAI combination be “associated”. As described above, the WTRU may provide the Session Identifier to the network so that the network may determine which PDU Sessions are associated, thus treatment of the PDU sessions can be differentiated based on the multi-modal data set each PDU Session is associated with. With this enhancement, many PDU sessions may use the same DNN/S-NSSAI combination and the network may determine which of the PDU sessions are associated with the same multi-modal set.

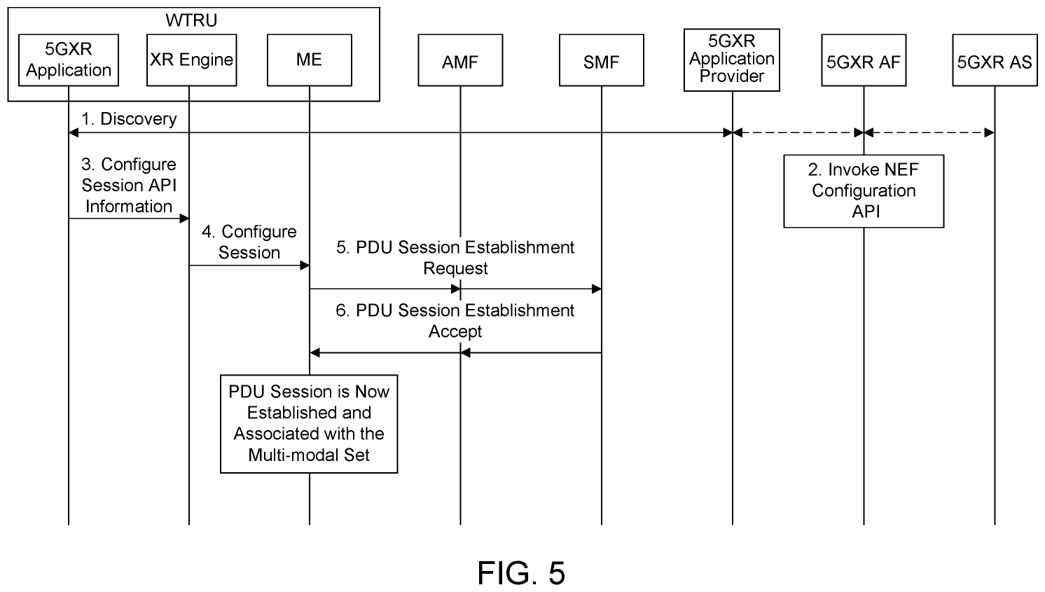

An example procedure of how the WTRU may assist the network in associating a PDU session with a multi-modal data set is shown in FIG. 5.

At step 1 of FIG. 5, the 5GXR application on the WTRU may perform a discovery procedure with the 5GXR application provider. The result of the discovery procedure may be that the 5GXR application on the WTRU may receive a session identifier (ID) and service access information. The service access information may include a traffic descriptor (e.g., an IP Address and port number of the traffic destination). As part of the discovery procedure, the 5GXR application may provide information to the 5GXR service provider about what services the 5GXR application wants to discover. For example, the 5GXR application may provide a flow type or application type (e.g., video stream, audio, etc.), a priority value, and/or location information during the discovery procedure so that the 5GXR application provider may provide a session ID based on that information.

At step 2 of FIG. 5, the 5GXR AF may invoke an NEF API to inform the network that a multi-modal data flow has been created. The API may be used by the 5GXR AF to provide the network with an application descriptor that maps to the Session Identifier and was provided to the 5GXR aware application as the session identifier. The API may also be used by the 5GXR AF to configure the network with the identities (e.g., external IDs of external group IDs) of devices that may be associated with the multi-modal data set.

The 5G AF may also be able to provide multiple policies to the NEF to be use through the lifetime of the XR session. For example, the 5G AF may provide multiple policies per single-modal flow and/or per WTRU. For example, each policy may be suitable for different frame rate values for video traffic.

The NEF may send the multiple policies to the PCF. The PCF may use the multiple policies to derive multiple sets of PCC Rules. The PCF may provide the sets of PCC rules to the SMF(s) that serve the PDU session of the XRM Session and the SMF may use sets of PCC rules to generate corresponding sets of QoS rules and N4 rules. The corresponding sets of QoS rules may be sent to the WTRU and the N4 rules may be sent to the UPF. Each set of QoS rules and set of N4 rules in the set may be associated with an index.

The WTRU may determine what rule to use when a WTRU hosted application provides a unit of information for transmission and the WTRU hosted application provides an index value.

For example, the WTRU hosted application may determine what index to provide to the WTRU based on how a codec is configured. The WTRU hosted application may have been configured with a mapping between codec/application settings and QoS index values. For example, if the WTRU is an XR session handler, the configuration information may have been received from a 5GXR AF via an X5 interface.

For each set of N4 rules, the PCF may provide a traffic detection rule, or a pointer to a traffic detection rule, to the user plane function (UPF). The UPF may use the traffic detection rule to detect the characteristics of the traffic and determine what N4 rules to apply.

At step 3 of FIG. 5, the 5GXR application in the WTRU will configure the XR engine in the WTRU with information about the multi-modal data set. The 5GXR application may provide the XR engine with the session identifier and service access information.

At step 4 of FIG. 5, the XR engine, which may be an application that runs in the TE part of the WTRU, may trigger the MT part of the WTRU to send a PDU session establishment request to the network. The XR engine may trigger PDU session establishment by explicitly requesting PDU session establishment (e.g., by invoking an AT command) or by beginning to send traffic to the MT part of the WTRU for transmission. When the XR engine triggers PDU session establishment, the XR engine may provide the session identifier and service access information to the ME. The service access information may include a traffic descriptor that is used by the MT during URSP rule evaluation. The PDU session establishment request may also include information that indicates the type(s) of application(s) that may use the PDU session.

Alternatively, the SMF may be able to use the Session Identifier to determine the type(s) of application(s) that will use the PDU Session.

At step 5 of FIG. 5, the WTRU may send a PDU session establishment request to the network. The PDU session establishment request may be a non-access stratum session management (NAS-SM) message and may be enhanced to include XR session information. The XR session information may be used by the SMF to recognize that the PDU session will be associated with a particular multi-modal data set. The SMF may use this information during UPF selection to ensure that a UPF is selected that is relatively close to the 5GXR AS, a UPF that may be used to communicate with the 5GXR AS, and/or a UPF that is the same UPF that is used by the PDU sessions of other WTRUs that are also associated with the multi-modal data set. The XR session information may also be carried in the NAS mobility management (NAS-MM) message that carries the PDU session establishment request so that the AMF may use the information during SMF selection (e.g., to select an SMF that can serve the multi-modal data set). In other words, the XR session information may be carried in both the NAS-MM and NAS-SM parts of the message so that both the AMF and the SMF may use the XR session information. The AMF may use the XR Session information in an SMF selection procedure. The SMF may use the XR Session information in a UPF selection procedure. XR Session information may be the session identifier that was provided to the 5GXR application in step 1 of FIG. 5.

At step 6 of FIG. 5, the SMF will send a PDU session establishment accept message to the WTRU. The PDU session establishment accept message may include QoS rules. The SMF may derive the QoS rules based on PCC rules that were received from the PCF. The PCC rules may be derived by the PCF based on information that was received from the NEF/5GXR AF.

For example, the 5GXR AF may have provided the network with latency requirements for the single modal flows of the multi-modal data set.

As described, the QoS rules that are provided to the WTRU may be enhanced so that they may be associated with a QoS rule index, or priority and assign QoS marking in a per-packet basis.

Also, as described, the QoS rules may be enhanced so that a QoS rule may indicate to the WTRU that packets that are part of a certain QoS flow should be dropped by the WTRU and not sent to the RAN node.

After step 6 of FIG. 5, the WTRU may have a PDU session established that is associated with the multi-modal data set and may be used to send and receive data that is associated with the multi-modal data set.

An example of policies associated with a multi-modal data set is described below

As described above, an NEF API may allow a 5GAF to configure information in the network about a multi-modal data set. The API may be an enhanced version of the Nnef_ParameterProvision API. The new API may be called Nnef_MultiModalDataSet API.

The API may be used to configure the following information about the multi modal data set in the network.

The API may allow the 5GAF to configure a DNN, S-NSSAI, and PDU session type to associate with the multi-modal data set.

The API may allow the 5GAF to configure application descriptors to associate with the multi-modal set. As described in TS 23.502, procedures for the 5G System (5GS); V 17.3.0, the application descriptors may be used to build URSP rules. As described in TS 23.503, Policy and charging control framework for the 5G system (5GS); Stage 2; V 17.3.0, the PCF may be configured with a mapping from application descriptor to other information required to construct the URSP rules, e.g., IP filters and SSC mode.

In various embodiments, it might be required for the traffic of a multi-modal session to have the same DNN/S-NSSAI combination. In this case the WTRU may need to have his URSP rules correctly established/configured. Invocation of the NEF API may trigger the PCF to provide WTRU(s) involved in the XRM session with an updated set of URSP rules. Each rule may have its unique precedence and may include a traffic descriptor as well as a list of route selection descriptors. Traffic descriptor may include IP descriptors (e.g., destination IP 3 tuple(s), application identifier, an FQDN, and a DNN provided by the application). As described below, the traffic descriptor may also include new component reflecting the XR session ID. The WTRU may know to match the traffic pertaining to a certain XR session (i.e., matching the traffic descriptor) to the correct DNN/S-NSSAI combination.

PCF may subscribe to receiving notification of policy data change for the multimodal session at the UDR. Once UDR detects a change, it may notify the PCF of the updated policy control subscription profile via Nudr_DM_Notify. Then the PCF may determine that WTRU policy info needs to be sent to the WTRU. PCF may send a policy association update request via a Npcf_URPolicyControl UpdateNotify request which includes new WTRU policy information (e.g., the URSP) to the AMF. This will trigger WTRU configuration update procedure to send information to WTRU via AMF, which will update URSP rules at the WTRU.

The API may allow the 5GAF to configure the network with information about what WTRU's may be associated with the multi-modal data set. The API may allow the 5GAF to identify the WTRUs with a list of GPSIs or an external group ID.

The API may allow the 5GAF to configure one or more Session Identifiers to associate with multi-modal data set.

The API may allow the 5GAF to configure the network with a multi-modal data set identifier.

The API may allow the 5GAF to indicate to the network which application descriptors and/or session identifiers are associated with each WTRU. The PCF may then use this association to determine which URSP rules need to be sent to the WTRU, which PCC Rules to derive for each WTRU's PDU session and which QoS rules to send to each WTRU. Without knowing this association, the PCF would need to send the same URSP rules and QoS rules to the WTRUs. In a scenario where one WTRU that is associated with a multi-modal set is generating small amounts of sensed environmental data and the other WTRU is steaming video, WTRUs may be provided with different QoS rules and different URSP rules.

Another advantage of associating different Session Identifiers with different WTRUs is that it allows the multi-modal data set to be configured such that not all flows are treated the same.

For example, some WTRUs that are associated with the multi-modal data set may be provided with session id-x. All of the WTRUs that use session id-x may be associated with high data rate environmental sensing data that is not critical. Other WTRUs that are associated with the multi-modal data set may be provided with session id-y. All of the WTRUs that use session id-y may be associated with low data rate environmental sensing data that is critical. Other WTRUs that are associated with the multi-modal data set may be provided with session id-z. All of the WTRUs that use session id-z may be associated with high data rate video streaming. Thus, all three session identifiers (session id-x, session id-y, and session id-z) may be associated with the same multi-modal data set and the traffic that is associated with each identifier may receive different treatment from the network.

The API may also allow the 5GAF to configure a synchronization requirement, or synchronization threshold, per Session ID, per Flow ID, or per flow descriptor (e.g., IP 5-Tuple). The synchronization requirements may be used by the PCF to derive PCC rules and URSP rules.

The 5GS may trigger policy change requests to the PCF. For example, if the QoS notification control is activated/included in the PCC rule generated by PCF, then the RAN may notify the PCF through SMF when the GFBR may no longer (or may again) be provided for a certain QoS flow.

This indication, although it may concern one specific single modal data (e.g. video traffic), may have implication on the other modalities used in this XRM session (e.g. audio, haptic, and so on).

The 5GS might need to reassess not only parameters and/or characteristics of the Qos flow conveying video traffic but also the other Qos flows involved in this XR session, to allow for example for a synchronous data delivery.

Synchronization requirements might need the 5GS to adapt other QoS flows as well. Adapting other QoS flows may mean that updated PCC rules may be sent to the SMF(s) that serve the PDU Sessions of the XR Session.

Additionally, if change in one modality (loss of data for a certain time interval) affects the other modality (e.g., another modality is to be treated differently (dropped) within that same interval, e.g., dropped), then the 5G system may be able to coordinate the handling of both modalities (e.g., set second modality to be dropped for a certain interval).

The PCF may receive, from the AF, an indication of when (e.g., a time) that policy updates may be applied to an XRM Session. SMF may receive from the PCF an indication about a specific time when the policies are to change. The PCF may prepare updated rules right after receiving the request from the AF, or the PCF may schedule a time when to treat the AF request, e.g., shortly before the indicated time by the AF for the new PCC rules to be enforced.

In the meantime, if PCF receives policy change requests, to be enforced immediately, or at a time before the pending previous request from the SMF, then this new request may be treated and the previous request may be now rejected. This may allow PCF to be in tune with any real time requests about policy change that might need to occur before the first request.

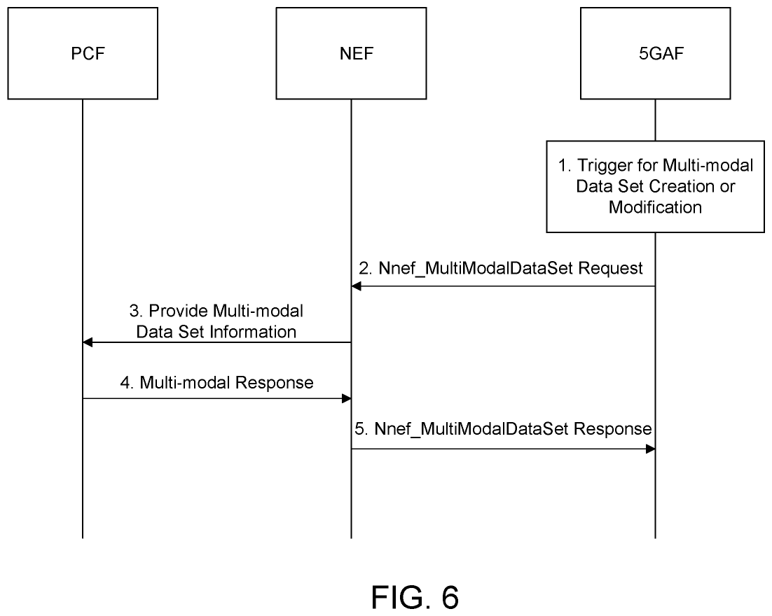

FIG. 6 shows an example procedure for how a 5GAF may create/configure or modify a multi-modal data set in the 5G System.

At Step 1 of FIG. 6, an event may trigger the 5GAF to create or modify the information that the network stores for a multi-modal data set. Examples of events that would cause the 5GAF to create or modify the information that the network stores for a multi-modal data set are a request from the 5GXR application provider, a request from the XR Session handler, and a request from the 5GXR AS. The request that triggers the 5GAF may include information about the multi-modal data set (e.g., service requirements), a session or multi-modal data set identifier, the identities of WTRUs that are associated with the multi-modal data set, a group identifier of WTRUs that are associated with the multi-modal data set.

At step 2 of FIG. 6, the 5GAF may invoke an NEF service to provide the information from step 2 to the 5G system. This service invocation may have the effect of informing the 5G system of what WTRU's are allowed to be associated with the multi-modal data set and how traffic from the multi-modal data should be treated (e.g., prioritized) by the 5G System.

The request from the 5GAF may include multiple QoS policies per flow and an index value per flow. Each index value may correspond to a session configuration (e.g., a codec setting) and, as described above, the WTRU and UPF may be configured with multiple QoS or N4 Rules and may be configured to determine which set of rules (i.e. which index) to apply.

At step 3 of FIG. 6, the NEF may invoke a BSF service to determine what PCFs serve the WTRUs that are associated with the multi-modal data set. The NEF may then invoke a service of each PCF in order to provide the PCF(s) with the information about the multi-modal data set. The information includes the identities of the WTRU(s) that may be associated with the multi-modal data set and includes the service requirements of the multi-modal data set. The PCF may use this information to derive PCC rules for flows of the multi-modal data set.

For a single modal data flow, some application layer parameters may be known in advance and may take a finite set of values. The 5GS may take advantage of this knowledge to anticipate different PCC rules to be prepared for future use for the multi-modal traffic. A non-limited example of this are the frame rate values for a video traffic (e.g. 60 fps, 90 fps.) which may impact a target guaranteed bit rate (GBR), while maintaining the same PDB requirement.

5GAF/NEF may request the PCF to prepare multiple PCC rules, for each modality, for different codec settings. The PCF may create the PCC rules and corresponding PDRs, QoS profiles and QoS rules for UPF, RAN and WTRU respectively.

The application layer may create indices for each codec setting and generates a mapping between these settings and the indices. When a specific coded setting is used, its index may be signaled to 5GC (e.g., PCF, SMF, UPF) and to the WTRU to enable selecting the appropriate policies and rules to be used.

At step 4 of FIG. 6, the PCF(s) respond to the NEF's service invocations. The PCF(s) may provide session identifier(s) (or service identifier(s)) to the NEF.

At step 5 of FIG. 6, the NEF responds to the 5GAF's service invocation. The response may include the session identifier(s) (or service identifier(s) that were received from the PCF(s).

The session identifier(s) (or service identifier(s) may be sent to the WTRU's 5GXR application by the 5GAF so that the WTRU may use the identifiers during PDU session establishment as described above.

An example of configuring a 5G system to detect a correct policy to apply is described below.

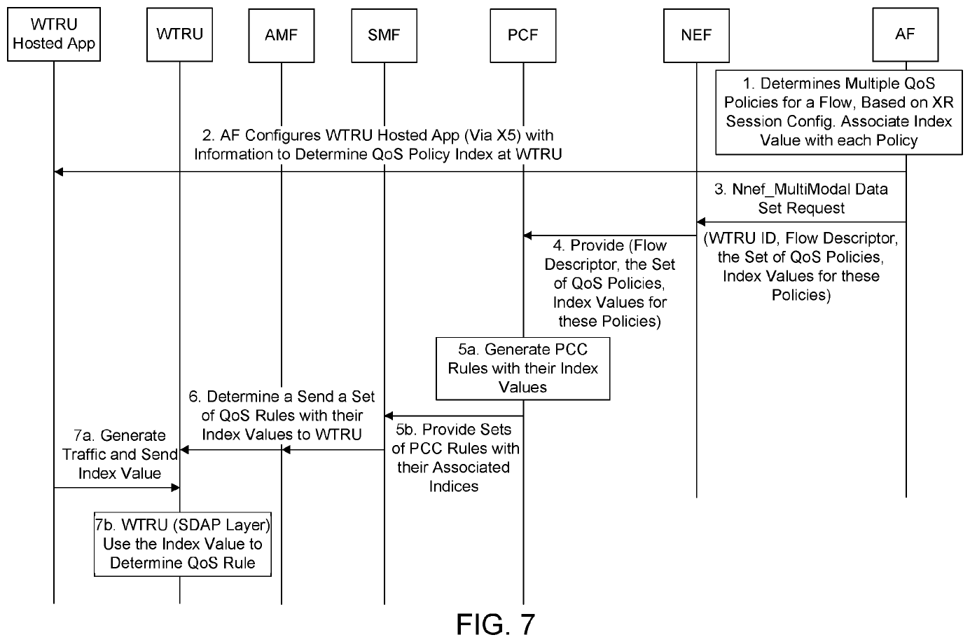

FIG. 7 shows an example procedure for configuration of 5G system for correct policy detection and enforcement.

At step 1 of FIG. 7, the AF may determine multiple QoS Policies for a flow. Which QoS Policy is used for the flow may depend on the XRM session configuration (e.g., a codec setting). The AF may associate an index value with each QoS policy.

At step 2 of FIG. 7, the AF may configure the WTRU hosted application with information that the WTRU hosted application may use to determine which QoS policy index may be used. For example, the configuration may indicate what QoS policy index may be used in each XRM session configuration (e.g., codec setting).

At step 3 of FIG. 7, the AF may invoke an NEF API to provide the network with a flow descriptor, a set of QoS policies, and an index value for each QoS policy.

At step 4 of FIG. 7, the NEF may provide the flow descriptor, the set of QoS policies, and the index value for each QoS Policy to the PCF.

At steps 5a and 5b of FIG. 7, the PCF may use the QoS policies to generate multiple sets of PCC rules and provide the multiple sets of PCC rules to the SMF that serves the session. The index that is associated with each PCC Rule may be provided to the SMF.

At step 6 of FIG. 7, the SMF may use each PCC rule to derive a set of QoS rules. The WTRU may receive from the SMF the QoS rules and the index value that is associated with each QoS Rule.

At steps 7a and 7b of FIG. 7, the WTRU hosted application may generate units of data to be sent (e.g., IP packets or video frames) and may indicate to the NAS layer of the WTRU which index is associated with the data. The service data adaptation protocol (SDAP) layer of the WTRU may use the index value to determine which QoS Rules to apply to the traffic. In other words, the SDAP layer of the WTRU may use the index value to determine which QFI marking to apply to the traffic.

An example of synchronizing the start of the single-modal flows of a multi-modal data set when the WTRU is in a connection management Idle (CM-IDLE) state is described below.

When activity starts in one flow, it may be advantageous to bring certain WTRUs out of the CM-IDLE state, even if these WTRUs are not receiving this flow. In other words, it might be necessary to anticipate that other WTRU's will soon need to wake up and receive low latency data.

For example, the 5GXR AS or 5GXR application provider may detect that it will soon be necessary for a WTRU to send or receive data from a single-modal flow of the multi-modal set. For example, this detection may be based on sensed data that was received by the 5GXR AS or 5GXR application provider. The sensed data may indicate an alarm condition that will trigger the need to stream additional video feeds.

An NEF API may be defined that allows the 5GXR AS or 5GXR application provider to indicate to the core network that certain WTRUs should be moved to the CM-CONNECTED state so that they are ready to send or receive data. In other words, moving the WTRUs to the CM-CONNECTED state will enable the WTRU to more quickly send or receive data when it becomes available.

The NEF API may be called Nnef_PendingData and the API may allow the API invoker (i.e. 5GXR AS or 5GXR Application Provider) to provide the network with the identities of the WTRU(s) that should be moved to the CM-CONNECTED state and may allow the API invoked to provide a time window that indicates when the WTRU should preferably be in the CM-CONNECTED state in anticipating of needing to send or receive data that is associated with the multi-modal data set.

The NEF API may also allow the invoker to indicate an IP 5-Tuple for the single-modal flow that will soon be activated. The network will use this information to determine which of the WTRU's PDU sessions need to be activated. Thus, appropriate user plane resources will be activated in anticipation of the WTRU receiving or sending data for the multi-modal set.

The NEF will query the BSF to determine the identity of the PCF that serves the PDU Session that is used to carry the single-modal flow. The NEF will forward the pending data notification to the PCF and the PCF will forward the notification to the SMF. The SMF will send a message to the AMF to indicate that user plane resources need to be activated in anticipation of the WTRU needing to send or receive data.

The AMF may use the time window information to determine when to initiate a paging procedure (e.g., an information procedure) for the WTRU and how long to keep the WTRU in the CM-CONNECTED state after the WTRU responds to the page by sending a service request message to the AMF.

When the start time of the time window is approaching, the AMF may initiate the paging procedure with the RAN node. The paging procedure is initiated by the AMF by sending a paging message to the RAN node. As described in TS 23.502, Procedures for the 5G System (5GS); V 17.3.0, the paging message may include a NAS ID for paging the WTRU.

In response to receiving the paging message, the WTRU may send a service request message to the AMF as described TS 23.502. The AMF will respond to the service request by sending an NAS-MM service accept message to the WTRU. The service accept message may be defined in TS 24.501, Non-Access-Stratum (NAS) protocol for 5G system (5GS); Stage 3; V 17.5.0. The service accept message may be enhanced to indicate that the service request message was triggered because it is anticipated that the WTRU may need to send or to receive data that is associated with a particular PDU session. For example, the service accept message may be enhanced to include a traffic anticipated information element. The traffic anticipated information element may be formatted like a PDU session status element as defined in TS 24.501 and illustrated in Table 1 which is copied from TS 24.501.

TABLE 1
PDU Session Status Information Element

| 8 | 7 | 6 | 5 | 4 | 3 | 2 | 1 | |
|---|---|---|---|---|---|---|---|---|
| PDU session status IEI | | | | | | | | octet 1 |
| Length of PDU session status contents | | | | | | | | octet 2 |
| PSI | PSI | PSI | PSI | PSI | PSI | PSI | PSI | octet 3 |
| (7) | (6) | (5) | (4) | (3) | (2) | (1) | (0) | |
| PSI | PSI | PSI | PSI | PSI | PSI | PSI | PSI | octet 4 |
| (15) | (14) | (13) | (12) | (11) | (10) | (9) | (8) | |
| 0 | 0 | 0 | 0 | 0 | 0 | 0 | 0 | octet 5*- |

| | |
|---|---|
| spare | 34* |

The purpose of the traffic anticipated information element may be to indicate, for each PDU session, whether the network anticipated traffic (e.g., but has no downlink traffic buffered yet). An PDU session inactive/active indications (PSI) in the information element maybe used to indicate whether traffic is anticipated for each PDU session. Additionally, the service accept message may be enhanced to further include a time window when the activity is expected to being within each PDU session.

When the WTRU receives an indication that traffic is anticipated within a certain PDU session, the WTRU may notify applications that are associated with the PDU session that uplink or downlink activity is soon expected. The MT part of the WTRU may notify applications that are in the TE part of the WTRU via an AT command. This notification may help ensure that the application is able to quickly respond when activity in the multi-modal set begins. The notification may include a time value that was derived from the time window information that was received in the service accept message.

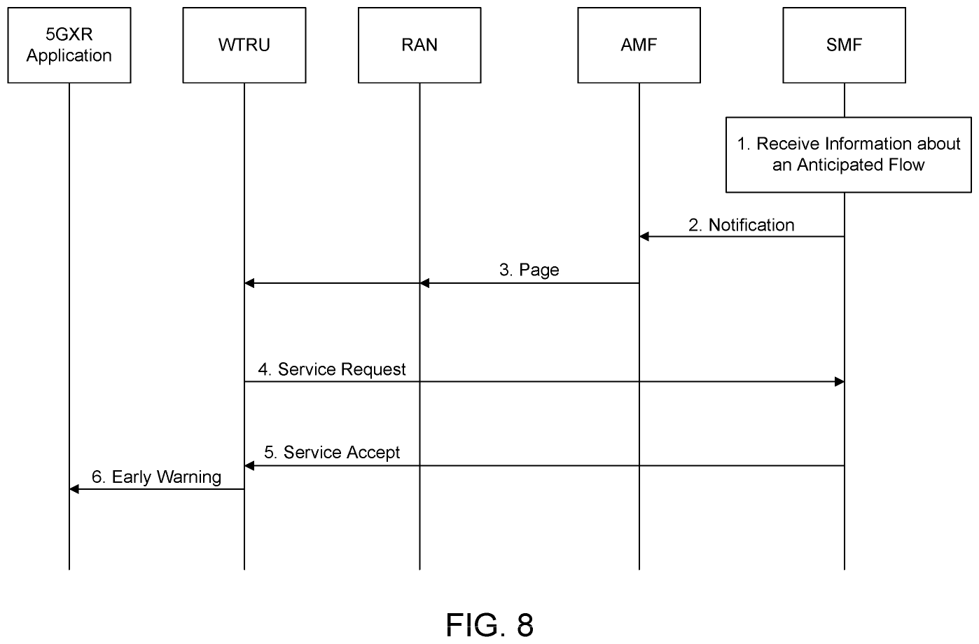

When the WTRU receives an indication that traffic may be anticipated within a certain PDU Session, the WTRU may notify other devices that are associated with the PDU Session that uplink or downlink activity is soon expected. This notification may help ensure that the other devices are able to quickly respond when activity in the multi-modal set begins. The other devices that receive the notification may be devices that connect to the WTRU via a non-3GPP radio such as a Bluetooth. The notification method from the WTRU to the device may be sent via a non-3GPP radio such as a Bluetooth radio. The notification may include a time value that was derived from the time window information that was received in the service accept message. An example of this procedure is shown in FIG. 8.

At step 1 of FIG. 8, the SMF may receive information about anticipated flow traffic and uses this information to determine that traffic will soon be generated in a multi-modal data set and that the user plane resources that are associated with the single modal data flows of the multi-modal data set should be activated. The information that the SMF may receive about anticipated flow traffic may be an indication that was triggered by the 5GXR AS in anticipation of traffic or it may be traffic pattern information that was configured in the network by the 5GXR AF.

At step 2 of FIG. 8, the SMF may send a notification to the AMF to inform the AMF of the anticipated traffic. The notification may be sent to the AMF by the AMF invoking the Namf_Communication_N1N2MessageTransfer service.

The Namf_Communication_N1N2MessageTransfer may be enhanced to indicate to the AMF that the notification was not triggered by the reception of the downlink data but was triggered by a determination of anticipated traffic. The message may be further enhanced to include time information in order to inform the AMF of when traffic is anticipated, thus the AMF may be able to delay paging the WTRU until the start time of the anticipated traffic is approaching.

At step 3 of FIG. 8, the AMF may send a request to the RAN to page (e.g., to inform) the WTRU and the WTRU may be paged.

At step 4 of FIG. 8, the WTRU may send a service request NAS-MM message to the AMF.

At step 5 of FIG. 8, the AMF may send a service accept NAS MM message to the WTRU. As described above, the service accept message may be enhanced to include a traffic anticipated information element and the information in the traffic anticipated information element may be used by the WTRU to determine to send a notification to applications that are hosted in the TE part of the WTRU that traffic in the multi-modal set is anticipated.

At step 6 of FIG. 8, the information in the traffic anticipated information element may also be used to trigger a notification, or early warning, to applications that are hosted on other devices. The notification, or early warning, may indicate that activity in the multi-modal data set is anticipated and the notification, or early warning, may indicate a time when the traffic is anticipated. For example, the other devices may be devices that are connected to the WTRU by means of a Bluetooth or WiFi connection. The other devices may generate, or receive, data that is part of the multi-modal data set and the other devices may route the data to and from the network via the WTRU's PDU session.

Additionally, the traffic anticipated information element may be sent to the WTRU in the registration accept message.

An example of synchronizing the start of the single-modal flows of a multi-modal data set when the WTRU is in a connection management connected state (CM-CONNECTED State) is described below.

In another example, the 5GXR AS or 5GXR application provider may detect that it will soon be necessary for a WTRU to send or receive data from a single-modal flow of the multi-modal set, the 5GXR AS or 5GXR application provider may provide this information to the network as described above, and the network may detect that the WTRU is in the CM-CONNECTED state.

As described above, the SMF may notify the AMF of this anticipated traffic. In an embodiment, the 5G system may be enhanced so that, when the WTRU is in the CM-CONNECTED state and the AMF receives a notification that traffic is anticipated for one of the WTRU's PDU sessions, the AMF may send a NAS message to the WTRU to notify the WTRU of what PDU Session the traffic is anticipated on. The NAS message may include the traffic anticipated information element as described above. The WTRU may use the traffic anticipated information element as described above (e.g., to notify applications and devices of the anticipated traffic). The NAS message that carries the traffic anticipated information element to the WTRU may be a NAS DL TRANSPORT message. The WTRU may stay in the CM-CONNECTED state, for the specified time, after receiving this traffic anticipated notification.

An example of prioritizing single-modal flows of a multi-modal data set is described below.

As discussed above, the QoS framework of the 5G System may allow an RAN node to be configured with alternative QoS profile(s) for a GBR QoS flow. The alternative QoS profile(s) may be provided to RAN node by the SMF. If the RAN determines that it cannot fulfil the QoS profile of the GBR QoS flow, the RAN node may apply one of the alternative QoS profile(s) for the GBR QoS flow and notify the SMF that an alternative QoS profile(s) is being applied.

When considering how the 5G system handles multi-modal data sets, the alternative QoS profile feature may be not sufficient because the feature requires that RAN node determines which flow(s) should utilize an alternative QoS profile. The RAN node may be not able to determine which flows are part of the same multi-modal set and which flows are lower in priority and less important to a multi-modal set. This is especially true when we consider that the relative propriety of the single-modal flows of a multi-modal set is dynamic.

It is proposed that the QoS framework of the 5G system be enhanced so that the WTRU may be configured with alternative QoS rules. For example, the WTRU may be provided alternative QoS rules in a PDU session accept or PDU session modification complete message. At least one (e.g., each) of the alternative QoS rules information elements may be formatted like a QoS rules information element. However, at least one (e.g., each) of the QoS rules information element of the alternative QoS rules information element may also include a precedence or index value. The alternative QoS rules may be provided to the WTRU in the PDU session establishment accept message in response to the WTRU sending the PDU session establishment request with an XR session ID.

Furthermore, it is proposed that the 5G system be enhanced so that the 5GXR AF may send a request to the network to adjust the QoS of a multi-modal set. The request may identify the multi-modal set by providing a combination of WTRU identifiers, S-NSSAI, and DNN. Alternatively, the request may explicitly identify the flows with an IP 5-Tuple. The request may also indicate the priority or index value of the associated QoS Rules/Profiles that should be applied. This information may be forwarded to each SMF that serves the PDU sessions of the indicated flows. The SMF may then send a NAS-SM message (e.g., PDU session modification request) with the index or priority of the QoS profile that should be applied. The WTRU may then apply a set of QoS rules from the alternative QoS rules information element instead of using the rules from the QoS Rules information element. The SMF may also send an N2 notification to the RAN node to instruct the RAN node to apply an alternative QoS profile.

Alternatively, the 5GXR application provider may use application layer messaging to indicate to the 5GXR aware application that an alternative QoS rule should be applied. The message may indicate the priority, or index, of the QoS rule. The 5GXR aware application may provide the priority, or index, of the QoS rule to the 5GXR client.

Alternatively, the 5GXR AS may use application layer messaging to indicate to the 5GXR aware application that an alternative QoS rule should be applied. The message may indicate the priority, or index, of the QoS rule.

Alternatively, the XR engine may use internal configuration, or policies to determine that an alternative QoS rule may be applied. For example, the XR engine may determine what QoS rule should be applied based on observed performance, roundtrip time (RTT) measurements (e.g., performance measurements function), etc. The XR engine may also determine a QoS rule to apply based on the type of packet that is being sent to the MT part of the WTRU for transmission. For example, the XR engine may determine that IP packets that are associated with an important part of a video frame should be associated with a first QoS Rule (e.g., high priority) and IP packets that are associated with a less important part of a video frame should be associated with a second QoS rule (e.g., best effort). The XR engine may receive alternative QoS rules from the 5GXR Application via the X6 interface or the XR engine may receive alternative QoS rules from the 5GXR AF via the X5 interface. The rules may describe what marking should be applied to each type of packet. The rules may further indicate under which conditions the rule should be applied. An example of a condition when a rule should be applied is a congestion level.

An example of improved QoS differentiation is described below

The XR engine may provide to the MT part of the WTRU a QoS rule index, or priority, so that the MT may determine which of the QoS rules to apply to a flow. The XR engine may provide the QoS rule index, or priority, on a PDU session basis, thus making the index semi-static for the PDU session. Alternatively, the XR engine may provide the QoS rule index, or priority, on a per-packet basis (e.g., provide the index with every packet that the XR engine sends for transmission) or the XR engine may provide the QoS rule index, or priority, only for packets that require one of the QoS rules from the alternative QoS rules information element.

The QoS framework may also be enhanced so that a QoS rule may indicate to the WTRU that packets that are part of a certain QoS flow should be dropped by the WTRU and not sent to the RAN node. For example, a new QFI value may be assigned to indicate to the WTRU that packets of the flow can be dropped. This reserved QFI value would provide a mechanism for the 5G system to block unimportant flows by applying an alternative QoS profile in the WTRU during times of congestion.

In an alternative approach, the URSP rule framework may be enhanced so that the traffic descriptor part of the URSP rule may include a traffic class differentiator Index. The traffic class differentiator index may indicate the relative importance of a piece of traffic and may be used by the URSP rules to map traffic from the same application flow to different PDU sessions. For example, packets from the same video stream may be assigned a different traffic class differentiator index by the XR engine. Each packet and its associated traffic class differentiator index may be provided to the MT part of the WTRU. The traffic class differentiator index will be evaluated by the MT part of the WTRU during URSP evaluation and the URSP rules may be configured such that packets from the same video stream may be sent via different PDU sessions. The network may configure different QoS rules for each PDU session. Continuing with the same example, each PDU session may be associated with a different DNN that maps to the same data network access identifier.

An example of consideration for peer-to-peer XR services is described below.

In an embodiment, although WTRUs involved in a peer-to-peer session do not exchange user plane traffic with 5GXR AF, WTRUs may still request the 5GXR AF to provide them with an XR session ID. The WTRU that initiates the session may send a request to the 5GXR AF via X5. The request from the WTRU may include a list of IDs of other WTRUs that they want to exchange XR traffic with. This may trigger the 5GXR AF to start Multi-Modal data set creation by invoking the Nnef_MultiModalDataSet request that was described above, and this may result in the AF obtaining a session identifier from the network (e.g., UDM) that may be used by WTRUs for the peer-to-peer communication. WTRU may provide 5GXR with XR service parameters (such as which modality of traffic is used) and through the Nnef_MultiModalDataSet API, 5GXR AF may provide QoS requirements for the peer-to-peer session.

As described above, the WTRUs may provide an XR session ID during the PDU Session establishment or modification request. If the WTRUs send the same XR session ID, the network may use that information to know that the incurred flows are associated. One way for the WTRUs to agree upon the session ID, may be to exchange this ID via a D2D link such as PC5.

In another embodiment, in addition to providing the XR session ID, the WTRUs may be configured with a group ID that can be obtained from the WTRUs SIMs. The Group ID may be in this way part of WTRU subscription. XR application may solicit the network to change the group ID parameter of certain WTRUs. Hence, different groups of peers using the same XR session ID may further be uniquely identified by means of the group ID and session ID that they provide during PDU Session Establishment.

In contrast to a client server architecture, the requirements of a peer-to-peer approach may be different. For example, in terms of latency requirement, a latency from one WTRU to another WTRU may encompass an uplink leg from the sending WTRU (for example WTRU1) to the anchor UPF, and a downlink leg from anchor UPF to the anchor of the receiving WTRU and then to the receiving WTRU (for example WTRU2). Therefore, to satisfy a latency requirement in one direction, the network may need to take latency requirements for both WTRUs, e.g., taking PDB1 and PDB2 for WTRU1 QoS flow1 uplink and WTRU2 QoS flow2 downlink.

The GBR of the traffic exchange between WTRU1 and WTRU2 in one direction may be the minimum of the GBRs of QoS flow1 and QoS flow2, mentioned above. Hence the network may need to be aware on how to map the service data flow (SDF) from the peer-to-peer traffic to the appropriate QoS flows for both WTRUs.

In an embodiment, the PCF may be provided with multiple values of QoS parameters (PDB, PER, GBR..) in terms of Qos flow, for each WTRU (e.g., for PDB parameters, PCF may receive PDB1 in {5 ms, 15 ms, 20 ms} and PDB2 in {10 ms, 15 ms, 30 ms}). When application QoS requirement (if application is aware that this is a peer-to-peer type of scenario, then it can be aware that this is a two-leg requirement) for XR services may be provided to the network, PCF may choose the best pair of QoS (one for each leg), to satisfy the requirements. For example, for a latency requirement of 30 ms for peer-to-peer XR service, PCF may select (15 ms, 15 ms) or also (20 ms, 10 ms) as the appropriate values for PDB1 and PDB2.

During the XR session, if the PDB in one leg changes, or QoS parameters change, then PCF may reassess involved QoS flows to make sure there is a successful combination. In the PCC rules, there may be indication of the QoS parameters (GBR, PDB), a session identifier to identify the XR session, a two-leg PDB or latency requirement and a list of WTRUs which may be exchanging peer-to-peer XR traffic within this session with WTRU (e.g., WTRU2).

If there is a change in the QoS parameters of a first QoS flow that is involved in peer-to-peer XR session, the SMF/PCF may check if there are two-leg requirements and if so, what other WTRUs (e.g., a list of WTRU IDs) may be involved in the session. Then PCF then may need to check the PCC rules of the QFIs of the other WTRUs involved in this session and reassess.

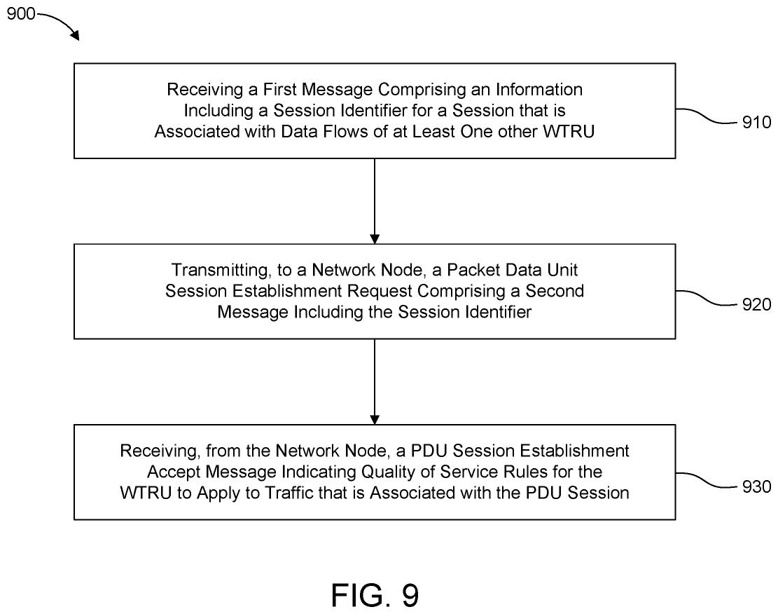

FIG. 9 depicts an example of a method 900 implemented in a WTRU for setting up a multi-modal data flow. The method 900 may comprise a step wherein the WTRU may receive 910 a first message comprising an information including a session identifier for a session that is associated with data flows of at least one other WTRU. The method 900 may comprise another step wherein the WTRU may transmit 920, to a network node, a packet data unit session establishment request comprising a second message including the session identifier; and the method 900 may comprise a step wherein the WTRU may receive 930, from the network node, a PDU session establishment accept message indicating quality of service rules for the WTRU to apply to traffic that is associated with the PDU session.

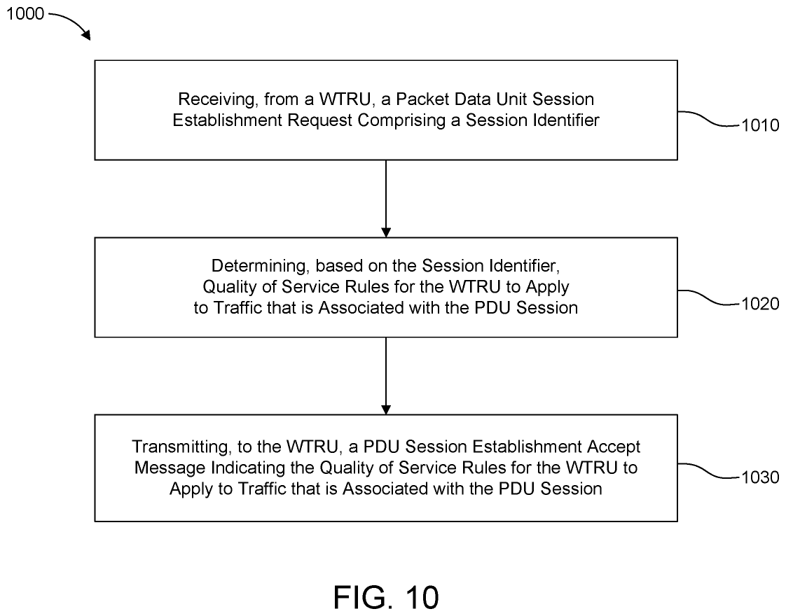

FIG. 10 depicts an example of a method 1000 implemented in a network node for setting up a multi-modal data flow. The method 1000 may comprise a step of wherein the network node may receive 1010, from a WTRU, a packet data unit session establishment request comprising a session identifier. The method 1000 may further comprise a step wherein the network node may determine 1020, based on the session identifier, quality of service rules for the WTRU to apply to traffic that is associated with the PDU session. The method 1000 may further comprise a step wherein the network node may transmit 1030, to the WTRU, a PDU session establishment accept message indicating the quality of service rules for the WTRU to apply to traffic that is associated with the PDU session.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1-26. (canceled)

27. A method, implemented in a network node, the method comprising:
receiving a first message comprising first information including service requirements for a data flow and second information indicating that the data flow is associated with a multi-modal data set;
determining, based on the second information, one or more policy and charging control (PCC) rules for a packet data unit (PDU) session of the data flow, wherein the one or more PCC rules are associated with the data flow; and
transmitting a second message comprising third information indicating the one or more PCC rules associated with the data flow.

28. The method of claim 27, comprising:
determining, based on the second information, a data network name and a single network slice selection assistance information (DNN/S-NSSAI) combination that is associated with the multi-modal data set; and
transmitting, to a wireless transmit/receive unit (WTRU), a third message comprising fourth information indicating a user equipment route selection policy (URSP) rule,
wherein the URSP rule includes the DNN/S-NSSAI combination, and wherein the WTRU is associated with at least one flow of the multi-modal data set.

29. The method of claim 27, wherein at least one other data flow is part of the multi-modal data set.

30. The method of claim 29, wherein the data flow is associated with a first WTRU, wherein the at least one other data flow of the multi-modal data set is associated with a second WTRU, and wherein the first WTRU is different from the second WTRU.

31. The method of claim 27, wherein the second information is a multi-modal data set identifier.

32. The method of claim 27, wherein the second message is transmitted to a session management function (SMF) network element.

33. The method of claim 27, wherein the first message is received from an application function (AF) network element.

34. The method of claim 33, wherein the first message is received from the AF via a network exposure function (NEF) network element.

35. The method of claim 27, wherein the network node is a policy control function (PCF) network element.

36. A network node, comprising a processor, a transceiver unit and a storage unit, and configured to:
receive a first message comprising first information including service requirements for a data flow and second information indicating that the data flow is associated with a multi-modal data set;
determine, one or more policy and charging control (PCC) rules for a packet data unit (PDU) session of the data flow, wherein the one or more PCC rules are associated with the data flow; and
transmit a second message comprising third information indicating the one or more PCC rules associated with the data flow.

37. The network node of claim 36, configured to:
determine, based on the second information, a data network name and a single network slice selection assistance information (DNN/S-NSSAI) combination that is associated with the multi-modal data set; and
transmit, to a wireless transmit/receive unit (WTRU), a third message comprising fourth information indicating a user equipment route selection policy (URSP) rule,
wherein the URSP rule includes the DNN/S-NSSAI combination and wherein the WTRU is associated with at least one flow of the multi-modal data set.

38. The network node of claim 36, wherein at least one other data flow is part of the multi-modal data set.

39. The network node of claim 38, wherein the data flow is associated with a first WTRU and the at least one other data flow of the multi-modal data set is associated with a second WTRU; wherein the first WTRU is different from the second WTRU.

40. The network node of claim 36, wherein the second information is a multi-modal data set identifier.

41. The network node of claim 36, wherein the second message is transmitted to a session management function (SMF) network element.

42. The network node of claim 36, wherein the first message is received from an application function (AF) network element.

43. The network node of claim 42, wherein the first message is received from the AF via a network exposure function (NEF) network element.

44. The network node of claim 36, wherein the network node is a policy control function (PCF) network element.
